(19) United States
(12) Patent Application Publication
(10) Pub. No.: US 2015/0318126 A1
(43) Pub. Date: Nov. 5, 2015

(54) Method for Producing a Switching Module and an Associated Grid Module, and an Associated Grid Module and Corresponding Electronic Subassembly

(71) Applicant: Robert Bosch GmbH, Stuttgart (DE)

(72) Inventor: Thomas Hessler, Lichtenstein (DE)

(21) Appl. No.: 14/651,194

(22) PCT Filed: Oct. 15, 2013
(86) PCT No.: PCT/EP2013/071475

§ 371 Date: Jun. 10, 2015

(30) Foreign Application Priority Data
Dec. 10, 2012 (DE) 10 2012 222 679.6

(51) Int. Cl. H01H 13/86; H01H 13/88; H01H 9/52; B29C 45/14

(52) U.S. Cl. CPC H01H 13/86; B29C 45/14065; B29C 45/14778; B29C 45/14336; H01H 13/88; H01H 9/52; B29C 2045/14163; B29L 2031/3443

(57) ABSTRACT

A method for producing a switching module that comprises at least one electronic component and at least one cooling element configured to cool the at least one electronic component is disclosed. The method comprises coupling the at least one electronic component with the at least one cooling element, inserting the at least one electronic component and the at least one cooling element into an injection mold, positioning a spring element between the at least one electronic component and an inner side of the injection mold, the spring element being supported on the inner side of the injection mold such that the at least one cooling element is pressed against a wall of the injection mold, and at least partially encapsulating the at least one electronic component and the at least one cooling element with a plastic.

### PRIOR ART

The invention is based on a method for producing a switching module of the generic type of independent patent claim 1 and a method for producing a grid module of the generic type of independent patent claim 8 and also on a grid module of the generic type of independent patent claim 11 and an electronic subassembly with such a grid module.

In the case of methods for producing switching modules, usually at least one electronic component is coupled with at least one cooling element and at least partially encapsulated by a plastic. The cooling element cools the electronic component during the operation of the switching module produced.

In the laid-open German patent application DE 199 12 443 A1, a description is given of a method for mounting and electrically contacting a power semiconductor component that comprises a metallic cooling element. The cooling element is designed as a support for the semiconductor chip and at the same time dissipates heat. Moreover, the cooling element provides a terminal contact for the semiconductor chip. The cooling element is mechanically and electrically and thermally connected to a terminal contact area of a conductor trace by laser welding.

In the laid-open German patent application DE 101 54 878 A1, a description is given of a holding element for fixing on a cooling element at least one electronic power component arranged on a printed circuit board. The holding element comprises a spring element, by which the electronic power component is pressed against the cooling element.

### DISCLOSURE OF THE INVENTION

The method according to the invention for producing a switching module with the features of independent patent claim 1 and the method according to the invention for producing a grid module with the features of independent claim 8 and also the grid module according to the invention and the electronic subassembly according to the invention have in comparison the advantage that both identical and different electronic components can be combined in one module, it being possible for these components to have different overall heights and different geometries.

As a difference from the methods known from the prior art, which at least partially encapsulate with plastic a substrate support that is loaded with electronic components, in the case of the methods according to the invention preferably already packaged or housed electronic components are at least partially encapsulated with plastic in order to produce a switching module or a grid module.

Embodiments of the present invention provide a method for producing a switching module that comprises at least one electronic component and at least one cooling element for cooling the at least one electronic component. The at least one electronic component is coupled with the at least one cooling element and at least partially encapsulated by a plastic. According to the invention, the at least one electronic component and the at least one cooling element are inserted into an injection mold, a spring element being arranged between the at least one electronic component and an inner side of the injection mold. The spring element is supported on the inner side of the injection mold in such a way that the at least one cooling element is pressed against a wall of the injection mold.

In the case of a method according to the invention for producing a grid module that comprises multiple switching modules, the components of the corresponding switching modules are inserted into the same injection mold and encapsulated in a joint process.

For partially encapsulating the electronic components and cooling elements, a liquid plastic that is cured after the encapsulation process is preferably used.

The electronic components may be designed as power components that produce large quantities of heat during operation.

The at least one cooling element may for example be designed as a metallic body with good thermal conductivities.

In an advantageous way, the spring element may compensate for different overall heights and different geometries of the electronic components during the production process. Consequently, in spite of imprecise mechanics of the individual electronic components, highly precise mechanics can be advantageously created in the composite assembly.

Also proposed is a grid module with at least two electronic components that are already packaged and/or housed and arranged in a composite assembly, each electronic component of the composite arrangement being respectively coupled with a cooling element and at least partially encapsulated with plastic. According to the invention, the cooling elements respectively form part of the outer surface area of the grid module and are arranged in a plane for removing heat from the electronic components via the outer surface area.

An electronic subassembly according to the invention comprises at least one such grid module with at least two electronic components.

In an advantageous way, the grid module according to the invention may be mounted as a module and not as tolerance-affected individually packaged components. By arranging the cooling elements in a plane, uniform heat removal from the electronic components is advantageously possible. Moreover, the plastic capsule advantageously facilitates the positioning of the grid module. Furthermore, smaller tolerances than are obtained merely by the injection-molding process can be made possible by the composite arrangement.

Advantageous improvements of the method for producing a switching module that is specified in independent patent claim 1 and of the method for producing a grid module that is specified in independent claim 8 and also of a grid module that is specified in independent claim 11 are possible by the measures and developments that are recited in the dependent claims.

In an advantageous refinement of the method according to the invention for producing a switching module, the at least one electronic component may be pressed against the at least one cooling element by the spring element. In an advantageous way, before the encapsulation the at least one electronic component may be reliably coupled in an interlocking and/or frictionally engaging manner with the corresponding cooling element by way of the spring force of the spring element.

In a further advantageous refinement of the method according to the invention for producing a switching module, the at least one electronic component may be aligned with the at least one cooling element in a predetermined direction by the spring element. In an advantageous way, the cooling element and the corresponding component can be brought into a predetermined position within the switching module by the alignment. Since the electronic components are aligned individually, the electronic components can advantageously have very small tolerances in the composite assembly of the encapsulating material, both in the plane and in height with regard to the clamping area.

In a further advantageous refinement of the method according to the invention for producing a switching module, the corresponding spring elements may compensate for different overall heights and/or tolerances of the electronic components. In an advantageous way, electronic components with different overall heights and tolerances can be arranged in the same injection mold and be encapsulated in a joint process. In an advantageous way, time can be saved by the joint encapsulation process.

In a further advantageous refinement of the method according to the invention for producing a switching module, a bearing area of the spring element on the at least one electronic component may be left clear during the encapsulation. This makes it possible that the spring element can be removed from the finished switching module after the encapsulation process, when the at least one electronic component is coupled with the cooling element by way of the encapsulating compound. In an advantageous way, the leaving clear of the bearing surface can be achieved by way of the injection mold, if for example the injection mold comprises an inner wall that separates the spring element from the encapsulating material.

In a further advantageous refinement of the method according to the invention for producing a switching module, an area of the at least one cooling element that is facing away from the at least one electronic component is left clear and aligned in a planar manner during the encapsulation. In an advantageous way, the planar area allows the completed switching module to be easily arranged on a plane that is designed for example as part of a printed circuit board and/or a leadframe. Furthermore, the heat that is transferred from the electronic component to the cooling element can be dissipated further by the cooling element by way of the left-clear area in the encapsulation, the cooling element being directly accessible for cooling by further cooling elements through the area that is left clear. As a result, uniform heat removal from the switching module can be advantageously realized. Furthermore, the completed switching module can be electrically contacted by way of the left-clear area of the cooling element if the cooling element is produced from electrically conductive material. This makes it possible for example for the switching module to be installed by a slug down method and/or a slug up method.

In a further advantageous refinement of the method according to the invention for producing a switching module, electrical connecting elements may be connected in an electrically conducting manner to the at least one electronic component and at least partially encapsulated. In an advantageous way, the electronic connecting elements may protrude from the encapsulating compound after the encapsulation process, and consequently be easily contacted in an advantageous way.

In an advantageous refinement of the method according to the invention for producing a grid module, webs may be formed between the switching modules during the encapsulation process. In an advantageous way, material and weight can be saved by the formation of webs. Furthermore, the individual switching modules could for example be easily separated from one another by cutting the webs, so that the fabrication of many switching modules in one encapsulation process can be facilitated.

In a further advantageous refinement of the method according to the invention for producing a grid module, at least one centering pin may be formed during the encapsulation process. The centering pin formed can advantageously facilitate alignment of the grid module on a printed circuit board and/or in a subassembly. For this, the centering pin may be inserted into a predetermined clearance, so that a translational movement of the grid module is prevented and a rotational movement about the centering pin is made possible.

In a further advantageous refinement of the grid module according to the invention, the encapsulating plastic may form at least one centering pin, in order to facilitate the positioning of the grid module during the mounting.

In a further advantageous refinement of the grid module according to the invention, identically aligned electrical connecting elements of the electronic components may be arranged on the side facing away from the cooling elements. This advantageously makes simultaneous electrical contacting possible, for example by way of leadframes.

In a further advantageous refinement of the grid module according to the invention, the encapsulating plastic may for example be a glass-fiber-reinforced plastic.

In a further advantageous refinement of the grid module according to the invention, the cooling elements are connected to at least one heat sink, in order to make good heat dissipation possible. The electronic components are preferably connected to one another by way of plastic webs. This advantageously allows material for the plastic encapsulation of the composite component assembly to be saved.

Exemplary embodiments of the invention are represented in the drawings and are described in more detail in the description that follows. In the drawings, the same reference numerals denote components or elements that perform the same or analogous functions.

### BRIEF DESCRIPTION OF THE DRAWINGS

FIG. 1 shows a schematic sectional representation of an injection mold with a switching module produced by the method according to the invention.

FIG. 2 shows a schematic sectional representation of a grid module produced by the method according to the invention.

FIG. 3 shows a schematic perspective representation of the grid module from FIG. 2.

Customary methods for producing a switching module couple at least one electronic component with at least one cooling element in one method step. The coupling may take place for example by way of a welding process, the at least one electronic component being firmly welded to the at least one cooling element. In a further method step, the at least one electronic component and the at least one cooling element is at least partially encapsulated by a plastic.

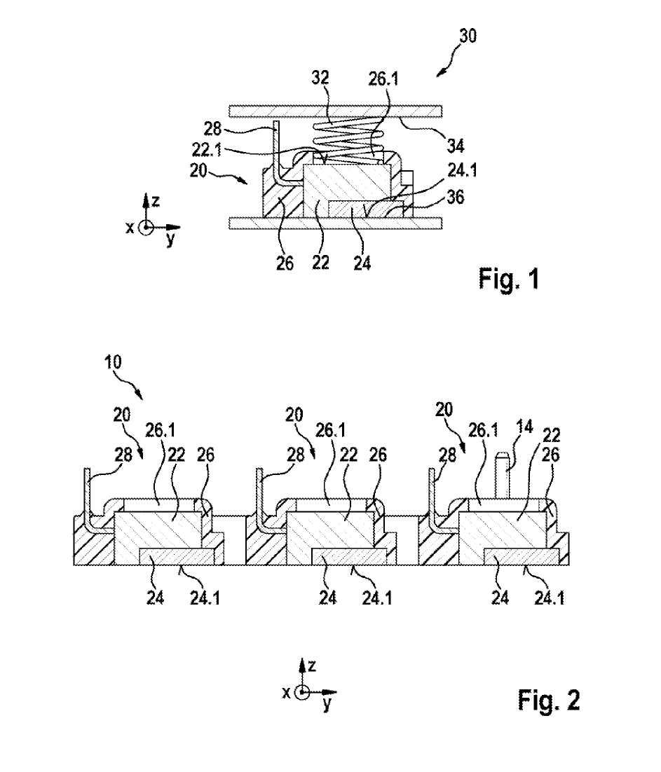

As can be seen from FIG. 1, according to the invention the at least one electronic component 22 and the at least one cooling element 24 of a switching module 20 are inserted into an injection mold 30, a spring element 32 being arranged between the at least one electronic component 22 and an inner side 34 of the injection mold 30. Here, the spring element 32 is supported on the inner side 34 of the injection mold 30 in such a way that the at least one cooling element 24 is pressed against a wall 36 of the injection mold 30.

In this way, the at least one cooling element 24 is fixed on the wall 36 of the injection mold 30 by the spring element 32, so that production tolerances of the electronic component 22 and the cooling element 24 in a first spatial direction z can be compensated, it being possible to prevent a positional change of the cooling element 24 during the encapsulating operation by the force of the spring element 32. If the switching module comprises multiple electronic components 22 with different overall heights and/or tolerances, these can be compensated by the corresponding spring elements 32. A glass-fiber-reinforced plastic may be used for example as the encapsulating plastic 26.

As can also be seen from FIGS. 1 and 2, the at least one electronic component 22 may have a clearance, in which the at least one cooling element 24 is arranged.

The switching modules 20 that are represented in the exemplary embodiments respectively have an already packaged or housed electronic component 22 and a cooling element 24.

As can also be seen from FIG. 1, the at least one electronic component 22 is pressed against the at least one cooling element 24 by the spring element 32. In this way, an interlocking and/or frictionally engaging connection is produced between the at least one electronic component 22 and the at least one cooling element 24. It would also be possible to couple multiple electronic components 22 with a cooling element 24, each electronic component 22 being pressed against the cooling element 24 by a corresponding spring element 32.

As can also be seen from FIG. 1, the at least one electronic component 22 is aligned with the at least one cooling element 24 in a predetermined direction z by the spring element 32.

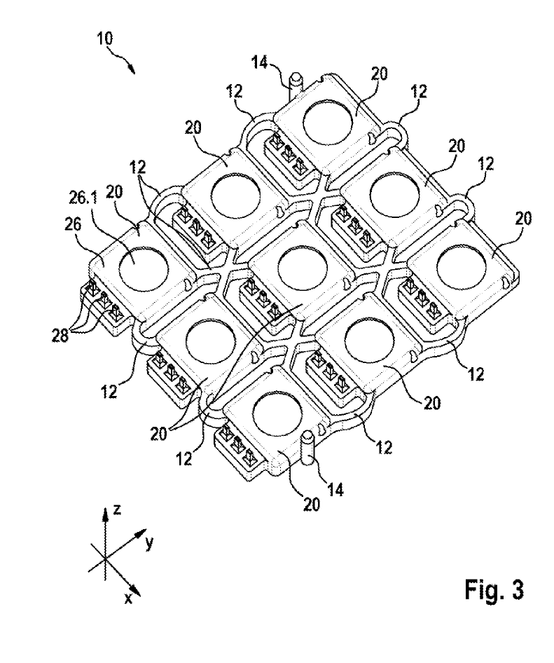

As can also be seen from FIGS. 1 to 3, a bearing area 22.1 of the spring element 32 on the at least one electronic component 22 is left clear during the encapsulation. In this way, the spring element 32 can be easily removed at the end of the production process, a clearance 26.1 that is represented in FIG. 3 being produced in the region of the bearing area 22.1 in the switching module 20. This clearance may subsequently be filled with a suitable filling material. A further possibility is not to remove the spring element 32 and likewise encapsulate it.

As can also be seen from FIGS. 1 and 2, an area 24.1 of the at least one cooling element 24 that is facing away from the at least one electronic component 22 is left clear and aligned in a planar manner during the encapsulation. In this way, a planar area of the switching module 20 is produced after the encapsulating operation, the at least one cooling element 24 being easily accessible for further cooling by way of the left-clear area 24.1.

As can also be seen from FIGS. 1 to 3, electrical connecting elements 28 are connected in an electrically conducting manner to at least one electronic component 22 and at least partially encapsulated. Here, one end of the connecting elements 28 may protrude from the switching module after the encapsulation process and make easy contacting of the corresponding electronic component 22 possible.

As can also be seen from FIGS. 2 and 3, it is also possible for multiple switching modules 10 that comprise at least one electronic component 22 and at least one cooling element 24 to be combined to form a grid module 10, in that the subassemblies 22, 24 of the corresponding switching modules 20 are inserted into the same injection mold 30 and encapsulated with plastic 26 in a joint process. The electronic components 22 that are represented have the same form and overall height, but it would also be conceivable that the switching modules 10 have different components with different overall heights, it being possible to compensate for the different overall heights by way of the corresponding spring elements 32.

As can also be seen from FIGS. 2 and 3, in the exemplary embodiment of the grid module 10 according to the invention that is represented, nine electronic components 22, which are already packaged and/or housed, are arranged in a composite assembly. Each of the electronic components 22 of the composite arrangement is respectively coupled with a cooling element 24 and at least partially encapsulated with plastic 26. According to the invention, the cooling elements 24 respectively form part of the outer surface area of the grid module 10 and are arranged in a plane for removing heat from the electronic components 22 via the outer surface area. The individual electronic components 22 are connected to one another by way of plastic webs 12.

As can also be seen from FIG. 3, in the exemplary embodiment of the grid module 10 according to the invention that is represented, the encapsulating plastic 26 forms two centering pins 14. The identically aligned electrical connecting elements 28 or line terminals of the electronic components 22 are arranged on the side that is facing the cooling elements 24 and can be easily electrically contacted, for example by way of a corresponding leadframe that is not represented. For the uniform removal of heat, the cooling elements 24 may be connected to at least one heat sink that is not represented.

As can also be seen from FIGS. 2 and 3, a grid module that is produced by the method according to the invention comprises at least one switching module 20. The exemplary embodiment represented comprises nine switching modules 20. These switching modules 20 may be designed identically and perform similar tasks or be designed differently and perform different tasks. Such a grid module 10 may be used together with other components that are not represented, for example as a power switching stage in an electronic subassembly.

Since the electronic components 22 and cooling elements 24 of the switching modules are aligned individually, the electronic components 22 can advantageously have very small tolerances in the composite assembly of the encapsulating material, both in the plane x-y and in the height z with regard to the clamping area. This means that the encapsulating material can compensate for the peripheral tolerances of the electronic components 22 and the cooling elements 24 in the x direction and the y direction and the tolerance in the height z by different material thicknesses of the encapsulation.

1. A method for producing a switching module that comprises at least one electronic component and at least one cooling element configured to cool the at least one electronic component, the method comprising:
coupling the at least one electronic component with the at least one cooling element;
inserting the at least one electronic component and the at least one cooling element into an injection mold;
positioning a spring element between the at least one electronic component and an inner side of the injection mold, the spring element being supported on the inner side of the injection mold such that the at least one cooling element is pressed against a wall of the injection mold; and
at least partially encapsulating the at least one electronic component and the at least one cooling element with a plastic.

2. The method as claimed in claim 1, wherein the at least one electronic component is pressed against the at least one cooling element by the spring element.

3. The method as claimed in claim 1, wherein the at least one electronic component is aligned with the at least one cooling element in a predetermined direction by the spring element.

4. The method as claimed in claim 1, wherein the spring element comprises corresponding spring elements configured to compensate for different overall heights and/or tolerances of the at least one electronic component.

5. The method as claimed in claim 1, wherein a bearing area of the spring element on the at least one electronic component is left clear during the encapsulation.

6. The method as claimed in claim 1, wherein an area of the at least one cooling element that is facing away from the at least one electronic component is left clear and aligned in a planar manner during the encapsulation.

7. The method as claimed in claim 1, further comprising:
electrically connecting electrical connecting elements in an electrically conducting manner to the at least one electronic component; and
at least partially encapsulating the electrical connecting elements.

8. A method for producing a grid module that comprises multiple switching modules, comprising:
coupling at least one first electronic component with at least one first cooling element;
coupling at least one second electronic component with at least one second cooling element;
inserting the at least one first electronic component, the at least one first cooling element, the at least one second electronic component, and the at least one second cooling element into an injection mold,
positioning a first spring element between the at least one first electronic component and an inner side of the injection mold, the spring element being supported on the inner side of the injection mold such that the at least one first cooling element is pressed against a wall of the injection mold;
positioning a second spring element between the at least one second electronic component and an inner side of the injection mold, the spring element being supported on the inner side of the injection mold such that the at least one second cooling element is pressed against a wall of the injection mold; and
at least partially encapsulating the at least one first electronic component, the at least one first cooling element, the at least one second electronic component, and the at least one cooling element with a plastic in injection mold in a joint process.

9. The method as claimed in claim 8, wherein the at least one first electronic component and the at least one first cooling element define a first switching module, and the at least one second electronic component and the at least one second cooling element define a second switching module, the method further comprising:
forming webs between the first switching module and the second switching module during encapsulation.

10. The method as claimed in claim 9, further comprising:
forming at least one centering pin during encapsulation.

11. A grid module, comprising
at least two electronic components that are packaged together and/or housed and positioned in a composite assembly, each of the at least two electronic components being coupled with a respective cooling element and at least partially encapsulated with plastic,
wherein each cooling element respectively forms part of an outer surface area of the grid module and is positioned in a plane and configured to remove heat from the at least two electronic components via the outer surface area.

12. The grid module as claimed in claim 11, wherein the plastic form at least one centering pin.

13. The grid module as claimed in claim 11, wherein the at least two electronic components each include identically aligned electrical connecting elements positioned on a side facing away from each respective cooling element.

14. The grid module as claimed in claim 11, wherein the plastic is a glass-fiber-reinforced plastic.

15. The grid module as claimed in claim 11, wherein each respective cooling element is connected to at least one heat sink.

16. The grid module as claimed in claim 11, wherein the at least two electronic components are connected to one another by way of plastic webs.

17. The grid module as claimed in claim 11, wherein the grid module is a part of an electronic subassembly.
